(19) United States
(12) Patent Application Publication
(10) Pub. No.: US 2005/0018046 A1
(43) Pub. Date: Jan. 27, 2005

(54) Picture display apparatus and method

(75) Inventor: Yoshiji Tsuzuki, Honjo-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/887,330

(22) Filed: Jul. 9, 2004

(30) Foreign Application Priority Data
Jul. 11, 2003 (JP) 2003-195980

(51) Int. Cl. H04N 3/20

(52) U.S. Cl. 348/173

(57) ABSTRACT

A picture display apparatus for displaying a picture on a screen by causing a fluorescent material coated on the screen to emit light, comprises an input picture processor processing input picture signal from picture signal source, and outputting picture signal, a signal converter receiving picture signal from input picture processor, and dividing, into a plurality of zones, a picture corresponding to picture signal and displayed on the screen, the signal converter processing a picture signal component belonging to each of the zones such that an area ratio of a certain zone included in the zones to the screen is increased, and an area ratio of another zone included in the zones to the screen is reduced, and a shift processor varying an area ratio of each of zones at predetermined timing, and shifting boundary lines of the zones of the picture displayed on the screen.

### CROSS-REFERENCE TO RELATED APPLICATIONS

This application is based upon and claims the benefit of priority from prior Japanese Patent Application No. 2003-195980, filed Jul. 11, 2003, the entire contents of which are incorporated herein by reference.

### BACKGROUND OF THE INVENTION

1. Field of the Invention

The present invention relates to a picture display apparatus and method for displaying a picture using a fluorescent material. Picture display apparatuses of this type include a plasma display apparatus and CRT display. More particularly, the invention relates to an improvement of a picture shift function for suppressing a burn-in phenomenon that may easily occur in such picture display apparatuses.

2. Description of the Related Art

In a panel display apparatus (hereinafter referred to simply as a “PDP”) such as a plasma display apparatus, a high voltage is applied to pixels to make them perform discharge, thereby generating ultraviolet rays and causing a fluorescent material to emit light. As a result, pictures are displayed. The fluorescent material degrades in proportion to the period of use. When it degrades, the amount of emission for the same amount of ultraviolet rays reduces. For example, if a signal for brightening only part of a screen in white is supplied for a long time, only the fluorescent material corresponding to the white portion is used and hence degraded. In this state, if the entire screen is brightened in white, the light intensity of the degraded portion is lower than the other portion, which can be noticed by the viewer.

The same phenomenon may also occur in, for example, a CRT display. However, in particular, in PDPs, since strong discharge is performed in extremely small pixels, degradation of the fluorescent material is especially conspicuous, therefore the fluorescent material degrades in a shorter time than CRTs. The phenomenon of reduction in light intensity due to degradation of a fluorescent material is called burn-in.

To avoid the burn-in phenomenon in PDPs, an improvement in fluorescent material and an improvement in pixel structure for increasing the efficiency of emission are possible. However, these methods mean fundamental improvements in the panel itself. Therefore, it is difficult to carry them out immediately.

In light of the above, a picture shift function is often utilized as a measure for preventing burn-in. This function shifts the entire picture at regular intervals. For example, the entire picture is slightly shifted at intervals of five minutes in the order of upward, leftward, downward and rightward.

In the picture shift function employed in conventional display apparatuses, the entire picture to be shifted includes a non-displayed over-scan region. Accordingly, an over-scan width is required for preventing the edges of a picture from being clipped. In addition, the over-scan width reduces the shift amount of the picture.

Further, since the picture shift is performed at regular intervals, if a picture shift time arrives in the state in which a still picture is being displayed, the viewer easily notices the shift of the still picture and is bothered by it. Furthermore, the shift pattern of a picture by the existing picture shift function is relatively simple, like a horizontal shift or vertical shift. A dynamic picture shift for more positively preventing burn-in is required.

Techniques related to the above technique are disclosed in Jpn. Pat. Appln. KOKAI Publication No. 2000-227775 (reference 1) and Japan Display '92 “S16-2 A Full Color AC Plasma with 256 Gray Scale”, pp.605-608 (reference 2). More specifically, reference 1 discloses a basic technique related to the existing picture shift function. Reference 2 discloses a general technique related to the operations of PDPs.

As described above, the picture shift function employed in the existing picture display apparatuses limits the amount of picture shift to avoid clipping of picture edges, which makes it difficult to acquire a desired burn-in prevention effect. Further, the conventional picture shift function can bother the viewer. A more effective burn-in preventing function is demanded.

### BRIEF SUMMARY OF THE INVENTION

According to an aspect of the present invention, there is provided a picture display apparatus for displaying a picture on a screen by causing a fluorescent material coated on the screen to emit light, comprises an input picture processor which processes an input picture signal from a picture signal source, and outputs a picture signal; a signal converter which receives the picture signal from the input picture processor, and divides, into a plurality of zones, a picture corresponding to the picture signal and displayed on the screen, the signal converter processing a picture signal component belonging to each of the zones such that an area ratio of a certain zone included in the zones to the screen is increased, and an area ratio of another zone included in the zones to the screen is reduced; and a shift processor which varies an area ratio of each of the zones at predetermined timing, and shifts boundary lines of the zones of the picture displayed on the screen.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a block diagram illustrating a picture display apparatus according to a first embodiment of the invention;

FIG. 2 is a schematic view illustrating a manner of processing by a shift process unit;

FIG. 3 is a schematic view illustrating another manner of processing by the shift process unit;

FIG. 4 is a flowchart useful in explaining the operation of a controller;

FIGS. 5A to 5C are conceptual views useful in explaining the advantage obtained by a third embodiment of the invention;

FIGS. 6A and 6B are conceptual views useful in explaining a pattern defined by shift points employed in the third embodiment;

FIGS. 7A and 7B are conceptual views useful in explaining another pattern defined as a comparative example by shift points; and

FIGS. 8A and 8B are conceptual views useful in explaining yet another pattern defined as a comparative example by shift points.

### DETAILED DESCRIPTION OF THE INVENTION

Embodiments of the invention will be described in detail with reference to the accompanying drawings.

(First Embodiment)

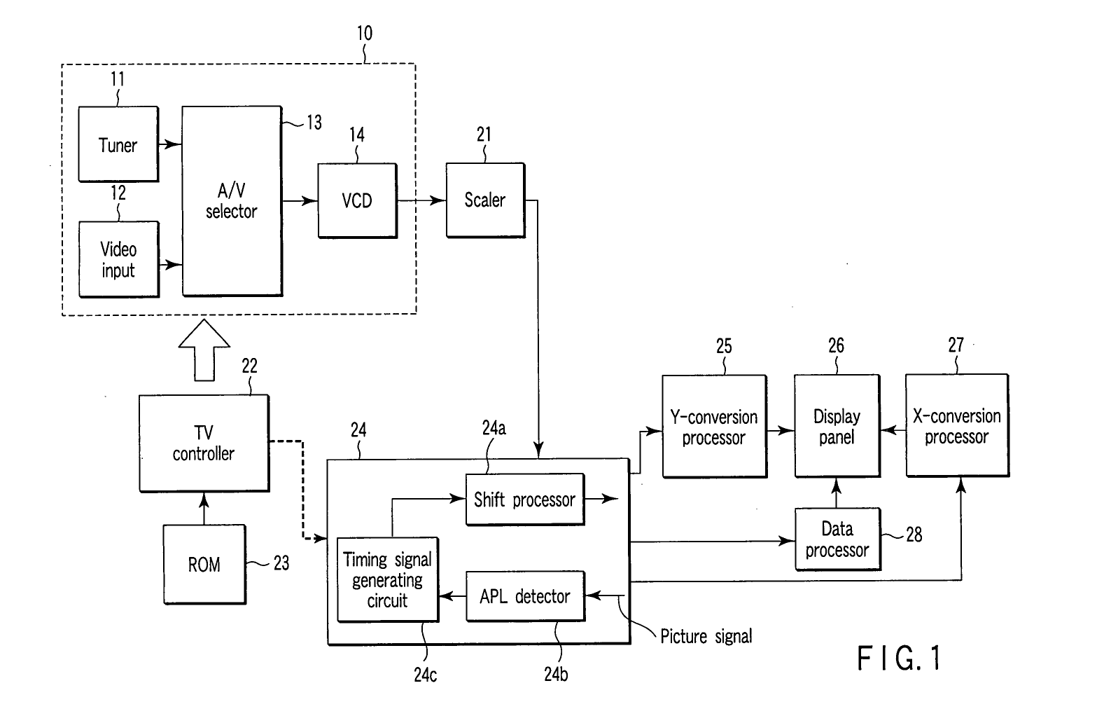

FIG. 1 is a block diagram illustrating a picture display apparatus according to a first embodiment of the invention. In FIG. 1, a video signal output from a signal processor 10 is supplied to a controller 24 via a scaler 21. The signal processor 10 incorporates an A/V selector 13 for selectively outputting video signals supplied from a tuner 11 and video input 12. The signal processor 10 operates under the control of a TV controller 22 based on data stored in a read only memory (ROM) 23. The tuner 11 receives TV broadcasting signals that are receivable in a region in which the picture display apparatus is installed. The tuner 11 selects one of the channels, and demodulates a video signal to be displayed.

The controller 24 acquires various types of data from the video signal and supplies them to a data processor 28. The video signal is also supplied to a Y-conversion processor 25 and X-conversion processor 27, where it is processed so that video data is compressed and expanded to the display size of a display panel 26. The data processor 28 controls the display panel 26 based on the data supplied.

The display panel 26 displays a picture on a screen (not shown) by making fluorescent materials of three colors, i.e., red (R), green (G) and blue (B), emit light.

The controller 24 comprises a shift processor 24a, APL detector 24b and timing signal generating circuit 24c. The shift processor 24a divides, into a plurality of zones, a picture displayed on the screen of the display panel 26, and shifts the boundary line of each zone at predetermined shift timing by varying the ratio of each zone to the screen. More specifically, the shift processor 24a varies the ratios of the length and width of each zone to the frame by varying the compression/expansion ratios of the Y-conversion processor 25 and those of the X-conversion processor 27 in units of several zones. The APL detector 24b detects an average picture level (APL) from a video signal.

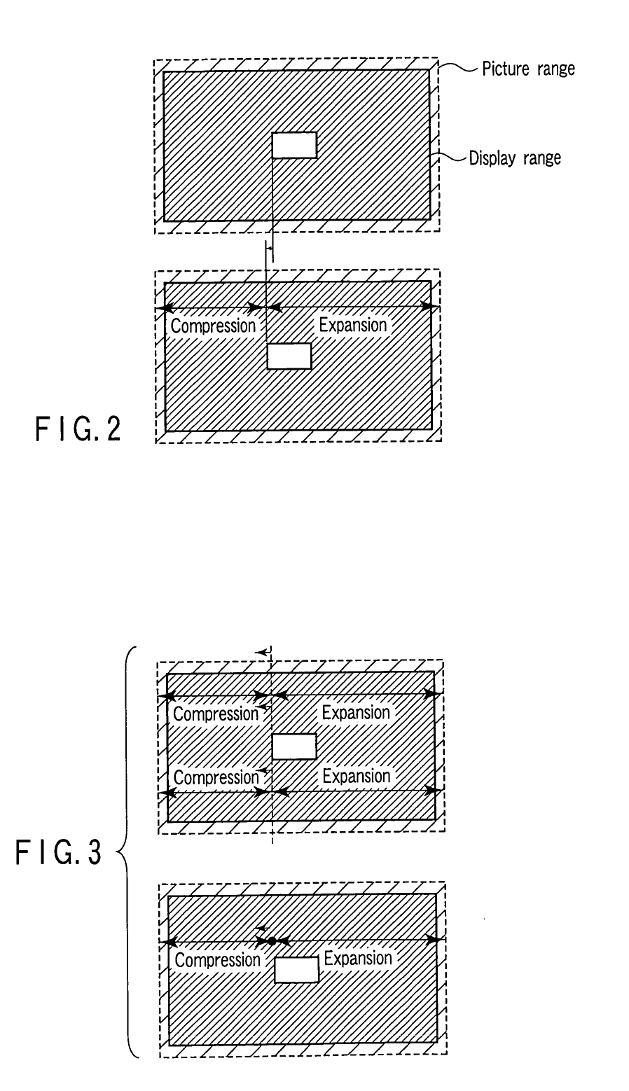

FIGS. 2 and 3 schematically show process manners of the shift processor 24a. To shift a picture positioned in an arbitrary position on the screen, as shown in FIG. 2, the compression/expansion ratios of a zone ranging from a picture edge including a non-displayed over-scan portion to a position to which the picture component is to be shifted are varied. This enables the picture component to be shifted like the conventional picture function, but without clipping picture edges.

To shift a picture only in a horizontal direction as shown in FIG. 3, compression/expansion processing is performed, regarding an arbitrary vertical line as the center of processing. Alternatively, compression/expansion processing may be performed, regarding an arbitrary pixel as the center. The same processing can be performed in a vertical direction.

When different compression/expansion ratios are used in units of picture zones, the picture is inevitably deformed. However, if the shift amount of the picture is small, no problem will occur. In currently available wide TV sets, when a picture of a (4×3) size is displayed on a wide screen of a (16×9) size, a mode is used in which the longer the distance from the center of the screen, the higher the expansion ratio. This also enables the picture to be displayed without a serious problem, although it is slightly deformed.

In particular, when virtual horizontal and vertical lines are arranged on the screen to divide the data frame, a picture is shifted regarding, as the center of a shift, each intersection of the vertical and horizontal lines. In this case, the remoter from each center position and closer to a screen edge the picture is positioned, the smaller the shift amount of the picture. Therefore, if the center position is shifted at regular intervals, the burn-in prevention effect of the entire screen can be enhanced. Further, a plurality of center positions are set, and shifts can be performed in respective portions including the center positions.

Time or channel number data displayed on a moving picture is considered to be an image that can easily cause burn-in. This is because the time or channel data is displayed in a fixed position at the upper right or left portion of the screen. Therefore, in this case, the above-mentioned center position is limited to the upper left portion and the upper right portion, and a shift may be performed alternately between the upper left and right portions.

Thus, in the picture display apparatus of the first embodiment for causing a fluorescent material coated on the screen to emit light to display a picture, a picture displayed on the screen is divided into a plurality of zones, and the area ratio of each zone to the entire screen is varied, thereby shifting the boundary lines of the zones at predetermined shift timing. This enables the positions of the picture edges to be fixed, which means that the displayed picture is not clipped even if its components are shifted. Further, the amount of shift can be determined without considering the over-scan width. Accordingly, burn-in of the screen can be prevented without clipping picture edges.

In addition, a display apparatus with fixed pixels, such as a PDP, already employs a compression/expansion processing unit for adjusting a to-be-displayed picture data size to the pixel size of the display apparatus, i.e., the Y-conversion processor 25 and X-conversion processor 27. In this embodiment, these processors are controlled to vary the compression/expansion ratios on a time basis. Therefore, the above processing can be performed without adding a large number of circuits or significantly changing the circuit.

(Second Embodiment)

A second embodiment of the invention will be described. In the second embodiment, the shift processor 24a shifts a picture at a time, at which it is difficult for the viewer to notice the shift of the picture, i.e., for example, when the picture is greatly changed. The timing signal generator 24c generates a timing signal for instructing the shift processor 24a to shift a picture, thereby controlling the starting time of a shift by the shift processor 24a.

To prevent the viewer from easily noticing the shift, it would be advisable to shift a picture when, for example, the display channel is switched, or commercials are started. In such a period, the viewer cannot easily notice even a relatively large amount of shift. For the detection of commercials, a mode discrimination function for teletext broadcasting, for example, can be utilized. This function is known as, for example, a CM cut function used during recording in existing video recording apparatuses. The timing signal generator 24c generates a timing signal for instructing a shift when the channel is switched or commercials are detected.

Further, in the second embodiment, the shift processor 24a controls at least picture shift timing or the shift amount of a picture in accordance with the detection result of the APL detector 24b. More specifically, if the APL detected by the APL detector 24b is substantially 0, i.e., if the picture is in substantially black, the shift processor 24a causes the picture to be shifted. Also in this case, almost no picture is displayed, and hence it is hard for the viewer to notice the shift of the picture.

Furthermore, at the point in time at which the APL is significantly varied, the displayed picture may well be varied significantly. Therefore, if the picture is shifted at this point in time, a similar effect can be expected. On the other hand, if the APL is not greatly varied, it is advisable to perform control so as not to shift the picture.

When a picture is shifted based on a change in the APL, the timing and intervals of shifts are irregular. The longer the shift interval, the less the effect of the picture shift function. In light of this, it is advisable to beforehand set the maximum shift interval, and to forcibly shift a picture if there is no chance of a shift, based on a change in the APL, within the maximum interval. The shift interval may be measured by, for example, a time-measuring function (timer) imparted to a microcomputer (not shown) incorporated in the TV controller 22. In this case, when a predetermined period has elapsed, the timing signal generator 24c is controlled to generate a shift instruction signal.

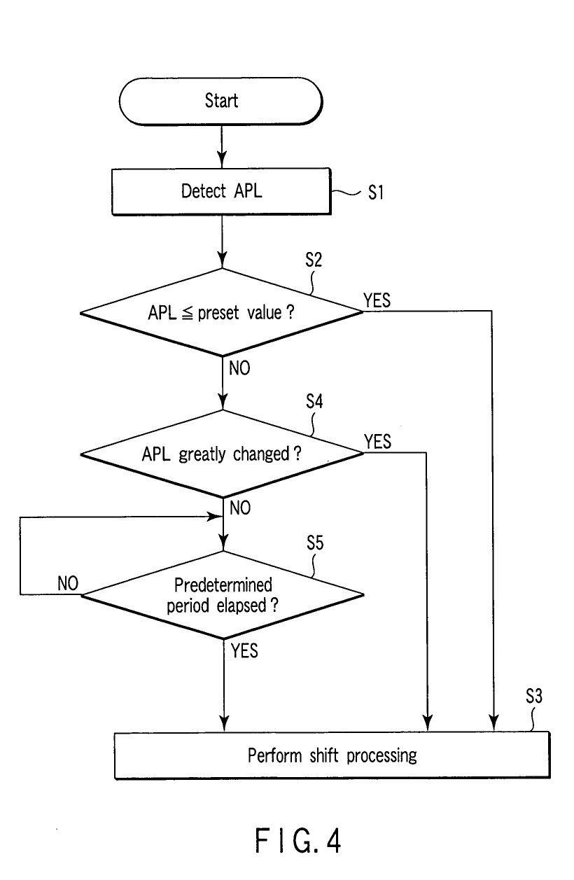

FIG. 4 is a flowchart useful in explaining the operation of the controller 24. In FIG. 4, the APL of a picture signal is detected at step S1, and it is determined at step S2 whether the detected APL is not higher than a preset level. If it is not higher than the preset level, picture shift processing is performed at step S3. At step S4, it is determined whether the APL is greatly changed. If it is determined that the APL is greatly changed, the program proceeds to step S3, where picture shift processing is performed. At step S5, it is determined whether a predetermined period has elapsed. If there is no change in the APL even after the predetermined period elapses, the program proceeds to step S3 where picture shift processing is performed. Thus, burn-in prevention corresponding to the APL can be achieved.

The amount of shift can also be varied in accordance with the period elapsing from the preceding shift. For example, if the period elapsing from the preceding shift is less than one minute, the amount of picture shift is only one pixel, while if the elapsed period is more than five minutes, the amount of picture shift is three pixels.

Further, the amount of one shift may be varied in accordance with a change in the APL. For example, the amount of change in the APL may be classified into three stages. In this case, in the minimum change stage, the amount of shift is set to, for example, 0. In the middle change stage, the amount of one shift is set to, for example, one pixel. In the maximum change stage, the amount of one shift is set to, for example, three pixels.

As stated above, since a picture shift is performed in accordance with the APL, when the channel is switched, or when commercials are detected, the possibility of the viewer noticing the shift is significantly reduced, thereby preventing them from being bothered by the shift.

(Third Embodiment)

A third embodiment of the invention will now be described. In the third embodiment, the effect of the burn-in preventing function is enhanced by employing an appropriate picture shift pattern.

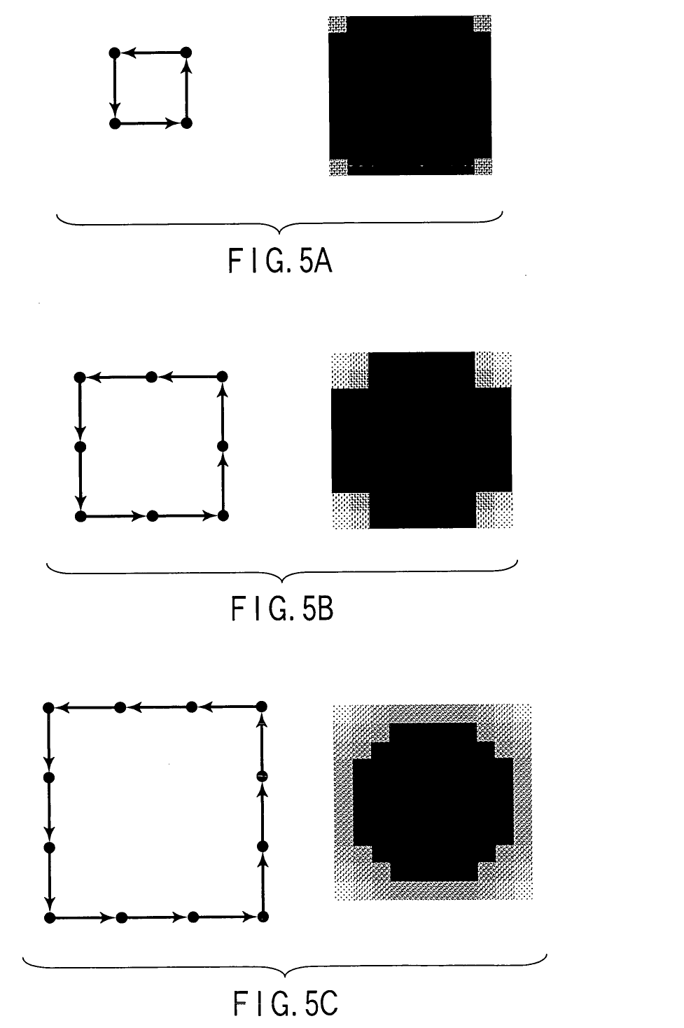

FIGS. 5A to 5C are conceptual views useful in explaining the advantage obtained by the third embodiment of the invention. In the picture shift function, the larger the entire amount of shift, the higher the burn-in prevention effect. In the third embodiment, the same advantage as the above is acquired by increasing the number of points related to shifting of a picture.

It is understood from FIGS. 5A to 5C that even if the shift patterns are all square patterns, the area of the central black portion is reduced when the amount of shift is increased. In other words, the burn-in prevention effect can be enhanced. It is also understood from these figures that the number of middle gradation (gray) regions is increased if the number of shift points is increased, which means more natural brightness change.

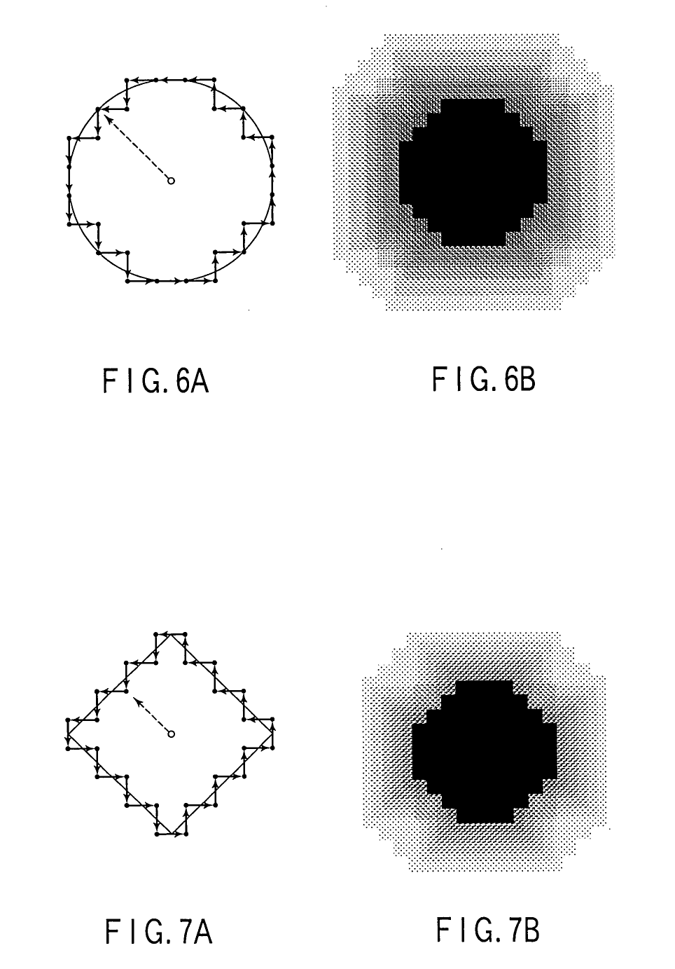

FIGS. 6A and 6B are conceptual views useful in explaining a pattern defined by shift points employed in the third embodiment. As seen from FIG. 6A, in the third embodiment, the shift processor 24a makes, substantially circular, the shift pattern defined by shift points. Specifically, in one cycle of shifting, a picture is made to shift along the circular shift pattern. In particular, in the third embodiment, the intersections of horizontal and vertical lines are made to shift along the circular pattern.

By virtue of this circular shift pattern, a picture is shifted along the shift points with the distance from the center kept substantially constant. As a result, the picture is shifted so that its portions uniformly overlap one another as shown in FIG. 6B, thereby effectively preventing the burn-in phenomenon.

FIGS. 7A and 7B are conceptual views useful in explaining a rhombus pattern defined as a comparative by shift points. The number of the shift points shown in FIG. 7A is equal to that of the shift points shown in FIG. 6A. However, in this comparative example, the central black portion shown in FIG. 7B is larger than that shown in FIG. 6B. This means that the circular shift pattern employed in the third embodiment has a higher burn-in prevention effect.

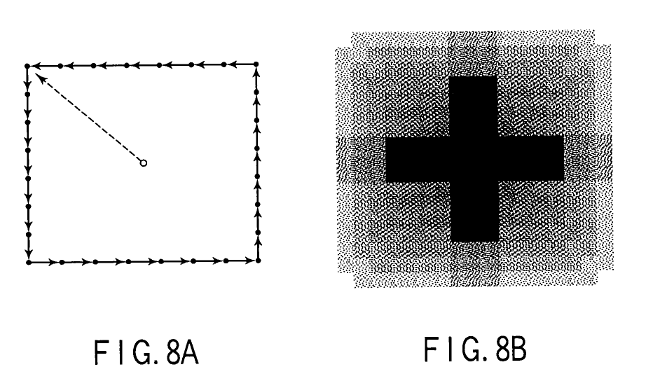

FIGS. 8A and 8B are conceptual views useful in explaining a rectangular pattern defined as a comparative example by shift points. The number of the shift points shown in FIG. 8A is equal to that of the shift points shown in FIG. 6A. However, in this comparative example, a conspicuous cross pattern appears when a picture is shifted in the horizontal and vertical directions. It is understood also from this that the circular shift pattern employed in the third embodiment has a higher burn-in prevention effect.

As described above, each embodiment of the invention can provide a picture display apparatus capable of effectively preventing the burn-in phenomenon without clipping picture edges or bothering the viewers.

The present invention is not limited to the above-described embodiment. For example, although the embodiments employ a PDP as a picture display apparatus, the invention is also applicable to any other display apparatus, such as a CRT display, which uses a material that may burn.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A picture display apparatus for displaying a picture on a screen by causing a fluorescent material coated on the screen to emit light, comprising:
an input picture processor which processes an input picture signal from a picture signal source, and outputs a picture signal;
a signal converter which receives the picture signal from the input picture processor, and divides, into a plurality of zones, a picture corresponding to the picture signal and displayed on the screen, the signal converter processing a picture signal component belonging to each of the zones such that an area ratio of a certain zone included in the zones to the screen is increased, and an area ratio of another zone included in the zones to the screen is reduced; and
a shift processor which varies an area ratio of each of the zones at predetermined timing, and shifts boundary lines of the zones of the picture displayed on the screen.

2. The picture display apparatus according to claim 1, wherein the signal converter makes constant a size of a display range on the screen by compressing a picture signal component belonging to a certain zone included in the zones, and expanding a picture signal component belonging to another zone included in the zones.

3. The picture display apparatus according to claim 1, wherein:
the input picture processor includes a channel selection circuit which selects one of a plurality of channels and outputs a picture supplied via the selected channel; and
the shift processor varies an area ratio of each of the zones to the screen when the channels are switched from one to another.

4. The picture display apparatus according to claim 1, wherein:
the input picture processor includes a switch unit configured to switch a plurality of input systems to select one of the input systems, and then to output a picture signal supplied from the selected input system; and
the shift processor varies an area ratio of each of the zones to the screen when the switch unit switches the input systems from one to another.

5. A picture display apparatus for displaying a picture on a screen by causing a fluorescent material coated on the screen to emit light, comprising:
an input picture processor which processes an input picture signal from a picture signal source, and outputs a picture signal;
a detector which detects an average picture level of the picture signal supplied from the input picture processor, and detect a change in a picture corresponding to the picture signal; and
a shift processor which processes the picture signal supplied from the input picture processor, and shifts a picture corresponding to the picture signal in a display range of the screen in response to the detection result of the detector.

6. The picture display apparatus according to claim 5, wherein:
the detector detects the change in the picture by detecting that the average picture level is not more than a preset value; and
the shift processor shifts the picture when the average picture level is not more than the preset value.

7. The picture display apparatus according to claim 5, wherein:
the detector detects the change in the picture by detecting that the average picture level is discontinuously varied; and
the shift processor shifts the picture when the average picture level is discontinuously varied.

8. The picture display apparatus according to claim 5, wherein:
the detector detects the change in the picture and a change in the average picture level; and
the shift processor shifts the picture in accordance with the change in the average picture level when the change in the picture is detected.

9. The picture display apparatus according to claim 5, wherein:
the detector generates a shift instruction signal when the change in the picture is not detected for a predetermined period; and
the shift processor shifts the picture in response to the shift instruction signal.

10. A picture display apparatus for displaying a picture on a screen by causing a fluorescent material coated on the screen to emit light, comprising:
an input picture processor which processes an input picture signal from a picture signal source, and outputs a picture signal;
a timing signal generator; and
a shift processor which shifts, on the screen, at least part of a picture corresponding to the picture signal in synchrony with a timing signal output from the timing signal generator, such that a locus of the picture is substantially circular.

11. The picture display apparatus according to claim 10, wherein the shift processor divides the picture using a horizontal line and a vertical line as boundary lines, and shifts an intersection of the horizontal line and the vertical line such that a locus of the intersection is substantially circular.

12. A picture display method employed in a picture display apparatus for displaying a picture on a screen by causing a fluorescent material coated on the screen to emit light, comprising:
detecting an average picture level of a picture signal corresponding to a picture displayed on the screen, and detecting a change in the picture; and
shifting the picture in a display range of the screen in response to the detected average picture level.

13. The picture display method according to claim 12, wherein the detecting includes detecting that the average picture level is discontinuously varied.

14. The picture display method according to claim 12, wherein the shifting includes shifting the picture by an amount corresponding to a change in the average picture level.

15. The picture display method according to claim 12, further comprising forcibly shifting the picture when a change in the average picture level is not detected for a predetermined period.
